(19) United States
(12) Patent Application Publication
(10) Pub. No.: US 2016/0197437 A1
(43) Pub. Date: Jul. 7, 2016

(54) HIGH SPEED CONNECTOR WITH SEALED HOUSING

(71) Applicant: MOLEX INCORPORATED, Lisle, IL (US)

(72) Inventor: Jeffrey A. Reeves, North Little Rock, AR (US)

(73) Assignee: Molex, LLC, Lisle, IL (US)

(21) Appl. No.: 14/916,623

(22) PCT Filed: Sep. 8, 2014
(86) PCT No.: PCT/US2014/054528

§ 371 Date: Mar. 4, 2016

Related U.S. Application Data
(60) Provisional application No. 61/874,400, filed on Sep. 6, 2013.

(51) Int. Cl. H01R 13/623; H01R 24/64; H01R 13/629; H01R 13/648; H01R 13/658

(52) U.S. Cl. CPC H01R 13/623; H01R 13/648; H01R 13/658; H01R 13/629; H01R 24/64

(57) ABSTRACT

A high speed connector assembly includes two interengaging connector halves each held in respective first and second interengaging connector housings. Each connector half includes a plurality of conductive contacts arranged in at least one linear arrangement and at least partially surrounded by a conductive grounding shield. The connector housings are cylindrical and engage each other in a circular fashion, while the connectors engage each other in a linear, axial fashion. The connector housings provide a sealed environment for the connectors.

### REFERENCE TO RELATED APPLICATIONS

The Present Disclosure claims priority to prior-filed U.S. Provisional Application No. 61/874,400, entitled “High Speed Connector With Sealed Housing Cable Assembly,” filed 6 Sep. 2013 with the United States Patent And Trademark Office. The content of the above Application is fully incorporated in its entirety herein.

### BACKGROUND OF THE PRESENT DISCLOSURE

The Present Disclosure relates, generally, to high speed connectors and, more particularly, to high speed connectors enclosed within sealed housings.

High speed connectors, such as USB and Esata connectors, are commonly employed in devices that utilize circuit boards for mounting the connectors; these devices are static devices in their operation, i.e., they are used in interior, stable environments with no exterior forces applied to them. It is desirable to incorporate these type connectors in dynamic environments, such as vehicles and aircraft, and as such, one must ensure that the connectors, when mated, are sealed from the environment and are protected from vibrations and other exterior forces that may cause the connectors to unmate and come apart. One connector specification, particularly for use in military applications, is the D38999 specification which requires connectors to be protected from environmental factors and of the quick connect/disconnect type. Typical D38999 connectors utilize a plurality of conductive pins arranged in a pin field in one of the connector housing halves and pin receptacles in the other connector housing half. The pins may bend, and pin fields must be painstakingly designed to derive selected electrical characteristics for the connector, which adds to the overall connector cost. Additionally, the small size available for the pin field may lead to problems in designing a pin arrangement for proper high-speed operation. High speed connectors that conform to USB and Esata specifications have desirable electrical characteristics, but have not been provided with an exterior structure that satisfies the requirements for military specification. Additionally, these flat style connectors need an enclosing ground structure available to their contacts for desirable coupling. A need therefore exists for a high-speed connector that suitably meets the standards of military specifications.

The Present Disclosure is therefore directed to a connector assembly particularly suitable for such applications, and which is vibration resistant but has quick connect capabilities.

### SUMMARY OF THE PRESENT DISCLOSURE

Accordingly, there is provided a connector assembly suitable for dynamic environments and which holds the high speed connector portions in place for mating.

In accordance with an embodiment as described in the following Present Disclosure, the connector assembly includes two interengaging male and female connector components. Each component includes a connector half with a plurality of conductive contacts, arranged in a linear fashion in at least one row. The connector halves respectively include opposing, interengaging male mating blade and female receptacle portions. Mating between the two connector halves of the connector components is effected by an axial, linear movement as in pushing the male mating blade into the female receptacle. In order to provide shielding to enhance the high speed performance thereof, each connector half has an integrated grounding shield associated with it held within an associated connector component. The connector contacts and their surrounding grounding shields are mated together during the linear connection movement.

The connector halves and their grounding shields are supported within inner, insulative connector housings held within the connector components. These connector housing halves are attached to supporting baseplates, such as by screws, and thereby enclose the connector halves therebetween in an integrated fashion as inserts within the connector components. The connector components further include connector body portions that partially enclose the connector halves and grounding shields with a structure that applies compressive forces to the connector body portions. In this manner, the connector halves are firmly held within between the baseplates and the housing halves in a manner that permits them to be mated in a linear, axial motion. They are also held so that the connector halves are isolated in the connector housings and not subject to extreme vibrations. The baseplates, connector housings and connector halves thereby form two integrated connector inserts, supported within first and second connector shells. Each connector shell has a hollow interior in which the connector insert is held.

The connector shells are preferably provided with exterior threads as one means of engagement, and one shell is larger than the other shell so that the two shells may be easily engaged in a telescoping fashion with one shell extending over the other shell. In this manner, the shells may be provided with O-rings or other type of environmental seals. In order to provide enhanced grounding for the high speed connector halves, at least one of the grounding shields associated with one of the two connector shells has a length that extends entirely through the connector housing insert, and this length is further equal or greater than the longest length of the exterior threads on the two connector shells. This provides an internal grounding shield that traverses about one-half of the connector length.

These and other objects, features and advantages of the Present Disclosure will be clearly understood through a consideration of the following detailed description.

### BRIEF DESCRIPTION OF THE FIGURES

The organization and manner of the structure and operation of the Present Disclosure, together with further objects and advantages thereof, may best be understood by reference to the following Detailed Description, taken in connection with the accompanying Figures, wherein like reference numerals identify like elements, and in which:

FIG. 1 is a perspective view of a connector assembly of the Present Disclosure, with the two connector components of the connector assembly mated together;

FIG. 2 is a perspective view of the connector assembly of FIG. 1, with the two is connector halves unmated;

FIG. 3 is an exploded view of the left connector half of the connector assembly of FIG. 1, taken from the rear;

FIG. 3A is a perspective view of the left connector component insert of FIG. 1, taken from the front and illustrated with the connector housing and baseplate spaced apart;

FIG. 4 is an exploded view of the right connector half of the connector assembly of FIG. 1, taken from the front thereof;

FIG. 5 is a sectional view of the connector assembly of FIG. 1, taken along Lines 5-5 thereof, with the connector components partially mated and with eSata style connector halves;

FIG. 6 is the same view as FIG. 5, with the connectors halves and their associated housings fully engaged;

FIG. 7 is a sectional view of two connector halves and their associated housings aligned with and partially mated to each other for mating, but with the connector halves being of the USB style;

FIG. 8 is the same view as FIG. 7, with the two connector halves and housing mated together;

FIG. 9A is an elevational view of the front, mating end of the female connector component of the connector assembly of FIG. 1; and

FIG. 9B is an devotional view of the front, mating end of the male connector component of the connector assembly of FIG. 1.

### DESCRIPTION OF THE PREFERRED EMBODIMENTS

While the Present Disclosure may be susceptible to embodiment in different forms, there is shown in the Figures, and will be described herein in detail, specific embodiments, with the understanding that the Present Disclosure is to be considered an exemplification of the principles of the Present Disclosure, and is not intended to limit the Present Disclosure to that as illustrated.

As such, references to a feature or aspect are intended to describe a feature or aspect of an example of the Present Disclosure, not to imply that every embodiment thereof must have the described feature or aspect. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the Figures, representations of directions such as up, down, left, right, front and rear, used for explaining the structure and movement of the various elements of the Present Disclosure, are not absolute, but relative. These representations are appropriate when the elements are in the position shown in the Figures. If the description of the position of the elements changes, however, these representations are to be changed accordingly.

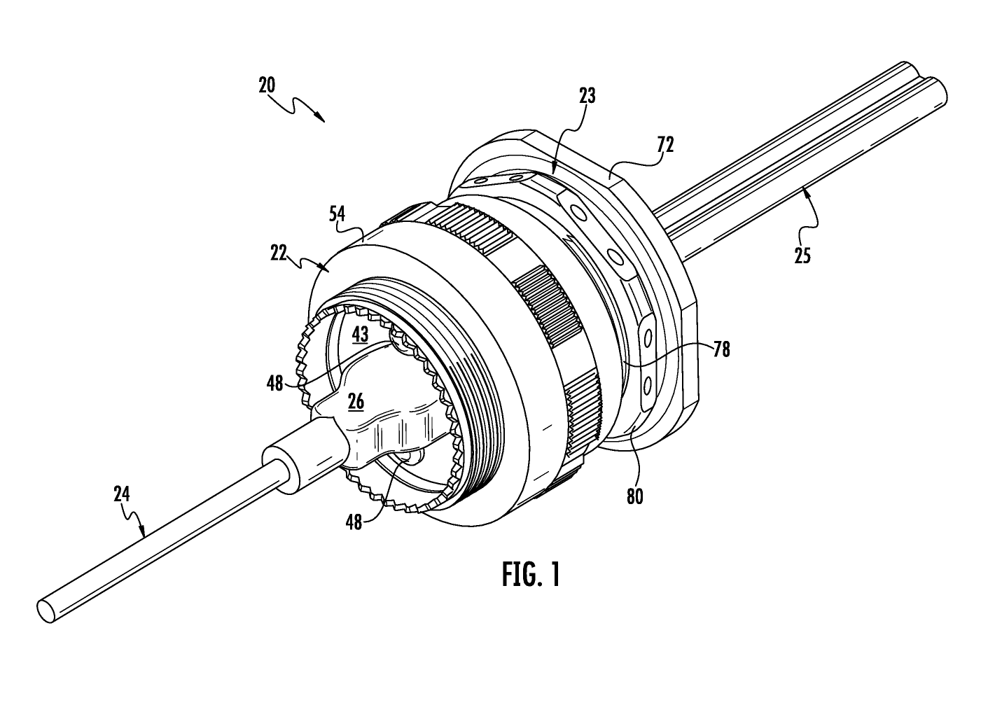

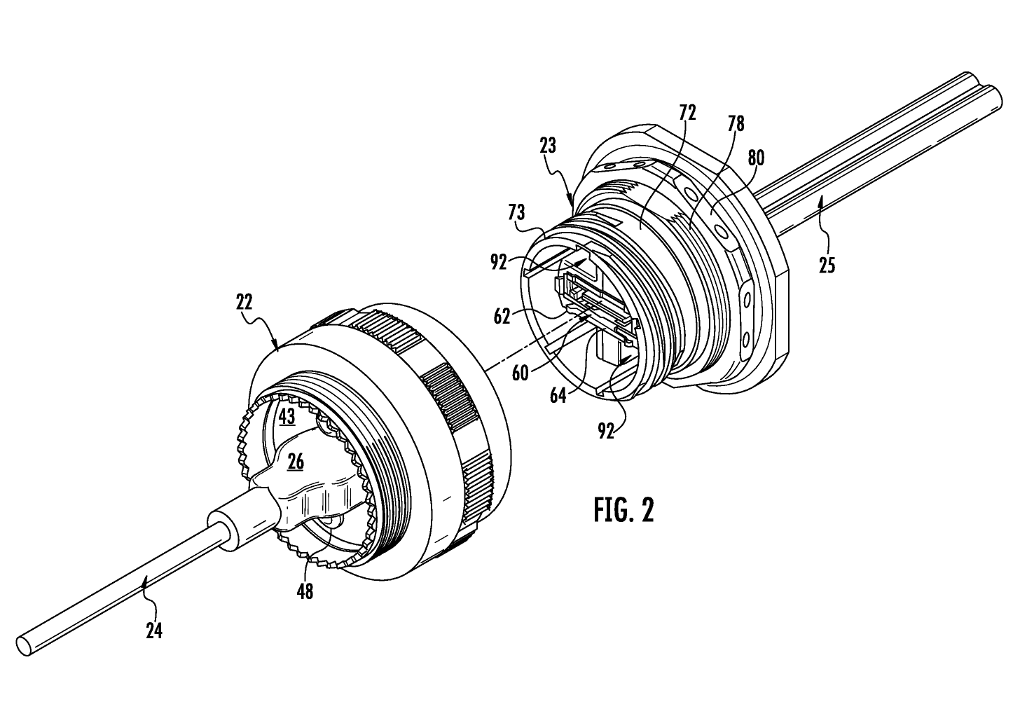

FIG. 1 illustrates a connector assembly 20 constructed in accordance with the principles of the Present Disclosure. The assembly 20 comprises matable first and second connector elements 22, 23 attached respectively to first and second electrical cables 24, 25. Each such cable 24, 25 contains a plurality of electrical wires (not shown). FIG. 2 is an exploded view of the first, or left connector element 22 and this connector element 22 includes a first connector insert that cooperatively includes an insulative, first connector housing 30, a first connector half 28 that includes first connector contacts 35 and a surrounding grounding shield 38, an overmolded first connector body portion 26, a baseplate 43, a retaining ring 52 and screws 48 that hold these items together as a connector insert.

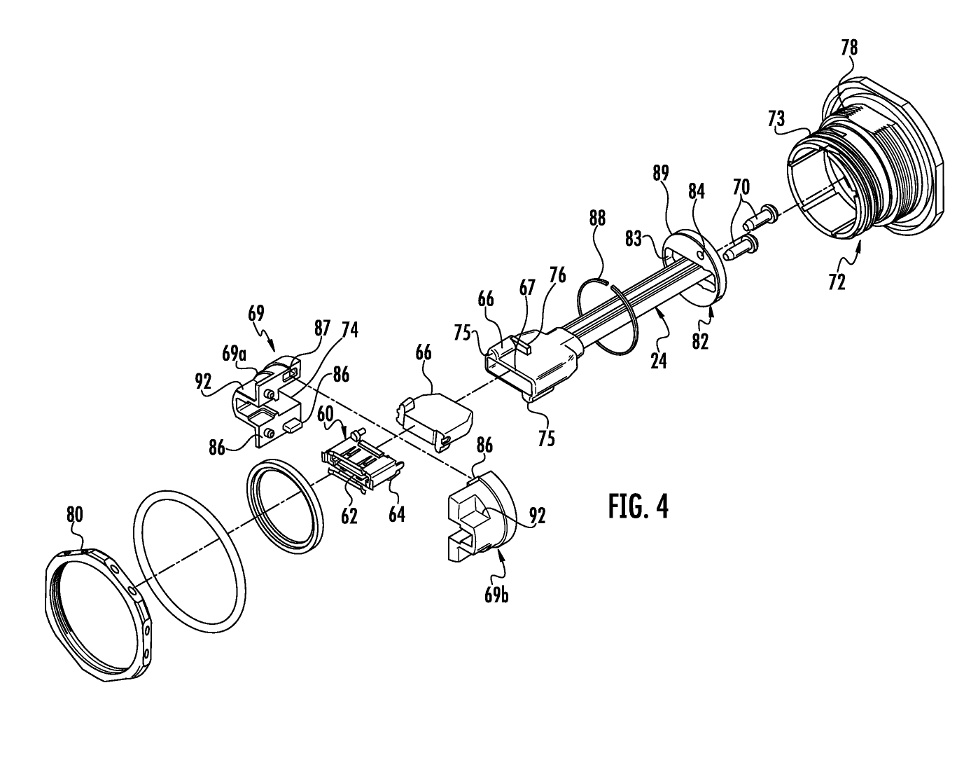

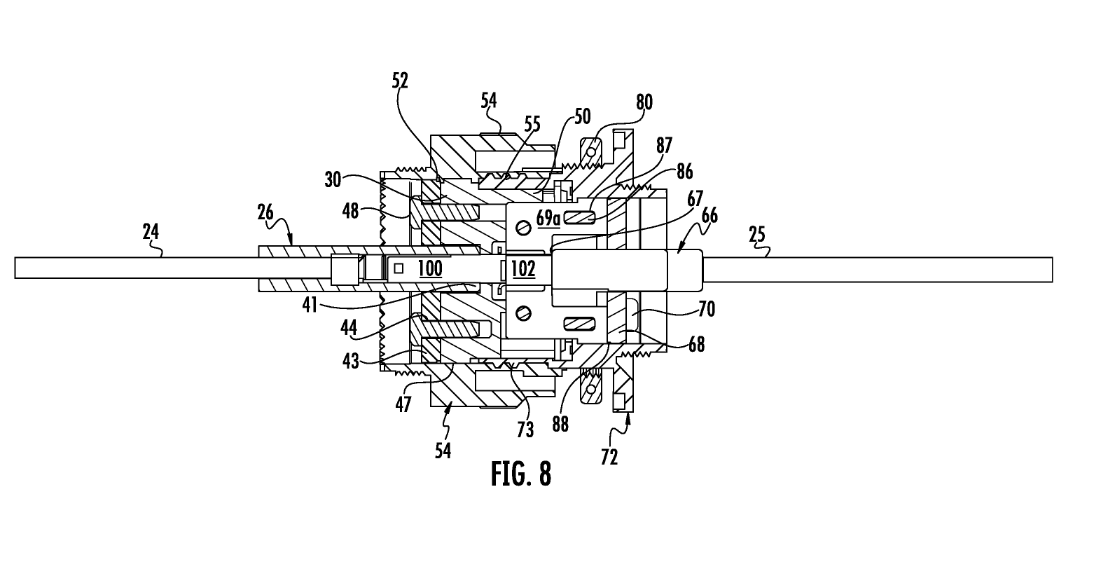

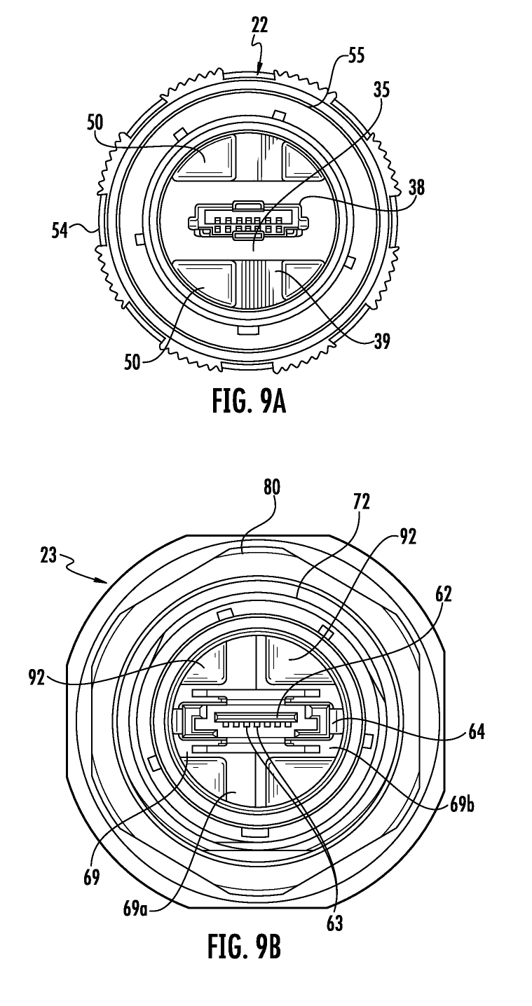

The first connector half 28 is held within a first connector body portion 26 that covers a portion of the first connector half 28 and the rear wire termination area thereof where the wires of the first cable 24 are terminated to the tail portions 35a of the first connector contacts 35. The first contacts 35 of the connector half 28, as shown in FIG. 5, are supported within a conductive grounding shield 38 that substantially surrounds the contacts 35, and a base portion of the grounding shield 38 is also held within the first connector body portion 26. The first connector half 28 of the first connector element 22 is shown as a female connector and as such, it includes a block 34 that supports a plurality of conductive first contacts 35 in at least one linear row upon a support surface of the block 34 with a receptacle 37. The contacts 35 are spaced apart widthwise along the block 34 and extend axially within the receptacle 37 and are covered by the first connector grounding shield 38 (FIG. 9A).

The first connector body portion 26 preferably is overmolded or insert molded in its construction. The first connector body portion 26 and associated first connector half 28 are received within a first vertical baseplate 43 that is circular in configuration. The first baseplate 43 includes a slot 44 through which portions of the connector body and grounding shields 36, 38 extend. These two components 26, 38 further extend forwardly and project into a corresponding opening 40 formed in the first connector housing 30. The connector body portion 26 is shown to include a pair of first (rear) stop surfaces 41 that take the form of ribs that oppose a front surface of the baseplate 43. Second (front) stop surfaces 42 are formed on the leading edge, or front of the connector body portion 26 and these bear against opposing interior shoulders 31 of the first connector housing 30. The first baseplate 43 includes one or more bores 45 that are aligned with corresponding openings 47 in the first connector housing 30. Screws 48, or other fasteners, are received in the bores 45 and openings 47 on that the first baseplate 43 press the first connector body portion 26 against the first connector housing 30 in a compressive manner. This compressive engagement serves to hold the first connector half 28 in place so that it will not move in response to external forces, such and shock forces and vibration forces.

The first connector housing 30 may further include one or more projections 50 that serve to polarize the first connector element 22 to mate only with the corresponding second connector element 23, and in an axial engagement movement. These projections 50 serve as mating keys for the connector assembly 20A, and are of varying size to ensure correct alignment and mating of the two connector elements 22, 23 in only one arrangement when they are first brought together. A retaining ring 52 is interposed between the first baseplate 43 and first connector housing 30, and it serves to hold the first connector insert in place within the first connector shell 54 via its connection to the first baseplate 43. The attachment of the first connector housing 30 to the first baseplate 43 encloses the first connector half 28 and body portion 26 therebetween. In this manner, the first connector half 28 and its associated contacts 35 and grounding shield 38 are restrained from any significant axial and lateral movement. Thus external shock and vibration loads should not negatively affect the mating of the connector elements 22, 23 together.

The left connector shell 54 houses the first connector insert and includes a cylindrical body 56 with a hollow interior 57. The hollow interior 57 has a counterbore 58 that defines an interior edge 59 against which a rim 53 of the left connector housing 30 bears. The retaining ring 52 is used to maintain the first connector housing 30 in position, and the first baseplate 43 has a channel 46 that accommodates the retaining ring 52. The second (right) connector element 23 also includes a second connector half 60 which is a male receptacle connector matable with the first connector half 28. The second connector half 60 is illustrated as a male receptacle connector of the eSata style, and includes a plurality of conductive second contacts 63, also arranged in at least one linear row upon an axially projecting mating blade 62. The second connector half 60 and its mating blade 62 is also surrounded by a conductive, hollow grounding shield 64, which is at least partially held in a second connector body portion 66 that encloses at least a portion of the second connector half 60. The first grounding shield 38 includes cantilevered contact portions 39 that contact the interior of the second grounding shield 64 when the two connector halves are mated together.

The second connector body 66 portion may be best applied thereto by way of insert or overmolding. The second connector body portion 66, grounding shield 64 and connector half 60 are held in a fixed orientation in a second, circular baseplate 68 received within a second connector shell 72. The second baseplate 68 is also attached to a second insulative connector housing 69, as by screws 70, to form a second connector insert held within the hollow interior of the second connector shell 72. The second connector housing 69 includes a lateral slot 74 which accommodates the second connector half 60 and a portion of its associate second grounding shield 64. The second connector body portion 66 is formed over the second connector half 60 and grounding shield 64 and this connector body portion 66 overlies the wire termination area of the second connector half 60 and serves to join the second connector half 60 to the second cable 24. The second connector body portion 66 has a leading edge 67 that is larger in dimensions than the second connector housing slot 74 and thereby defines a forward stop surface 75 thereof that engages an inner shoulder 77 formed in the opening 83 of the second connector housing 69. The baseplates are preferably held in their respective connector shells in a manner that permits them to rotate with respect to the outer connector shells so that the cables are not twisted when the connector shells are threaded together.

The second connector housing 69, as shown in FIG. 4, may be formed from two pieces 69a, 69b that each include complementary shaped engagement mugs 86 and recesses 87 for joining the two pieces 69a, 69b together. The second connector body portion 66 may also include, as shown in FIGS. 4-5, a rear stop surface 76 that extend transversely and abuts, or otherwise contacts, the front face of the second baseplate 68. The front and rear stop surfaces 75, 76 respectively contact the second connector housing 69 and baseplate 68 so that when the second baseplate 68 is attached to the second connector housing 69 via the screws 70, the second connector body 66 is placed under compression. In this manner, both the first and second connector body portions 26, 66 are held in compression in their respective connector elements 22, 23 which prevents significant, if not entire, axial and lateral movement that may occur due to external shock or vibration. The exterior of the second connector shell 72 is threaded and these threads 73 engage corresponding threads 55 on the inner surfaces of the first connector shell 54. Another exterior surface 78 of the second connector shell 72 is threaded and it supports a stop ring 80 so that the second connector element 23 may be mounted to a panel. The front face of the second connector housing 69 may include recesses 92 that receive the projecting lugs 50 formed on the first connector housing 30 FIG. 9B). These recesses 92 are also of the same varying size as the first connector housing projections 50 to affect their keying function properly. Both the first and second connector inserts are held in place within their associated exterior shells 54, 72 in a manner so that they are free to rotate therewithin. In place of the exterior threads, the two connector shells may include a bayonet-type mounting structure that will also permit the quick connect and disconnect of the two connector elements 22, 23.

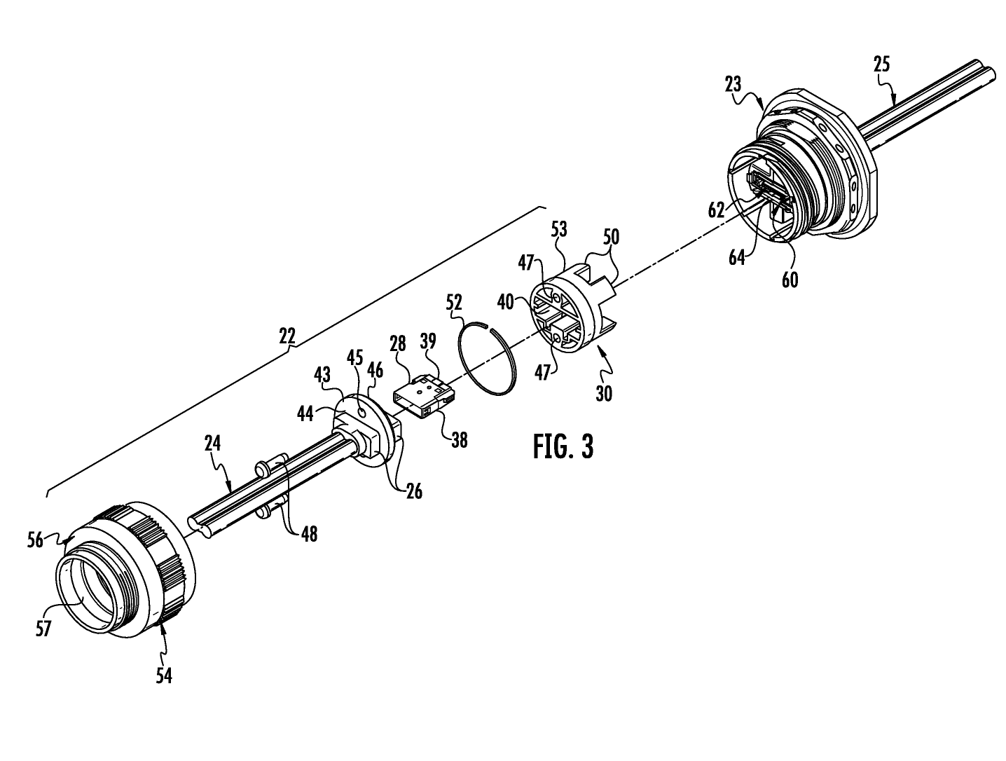

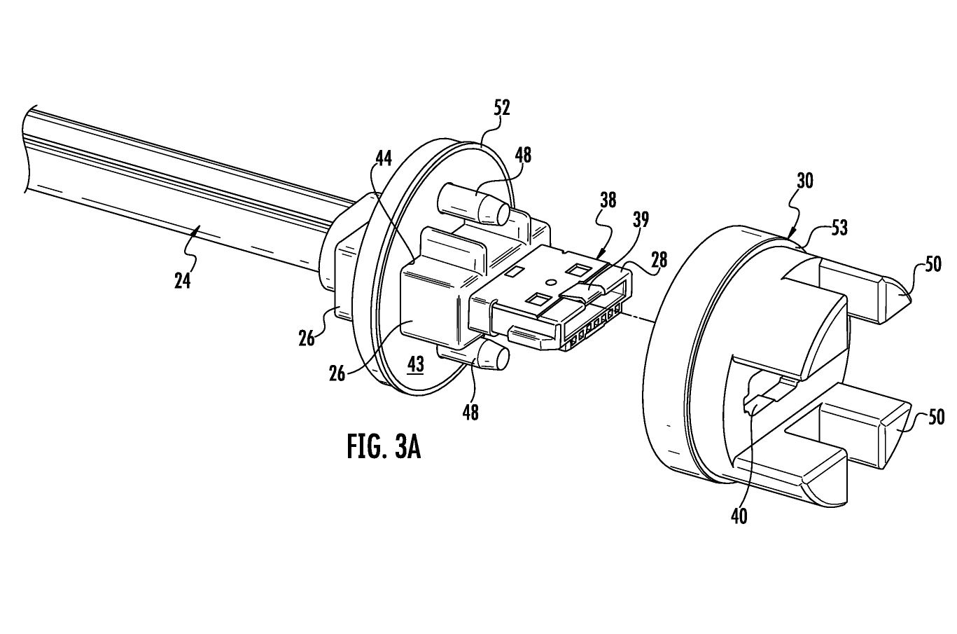

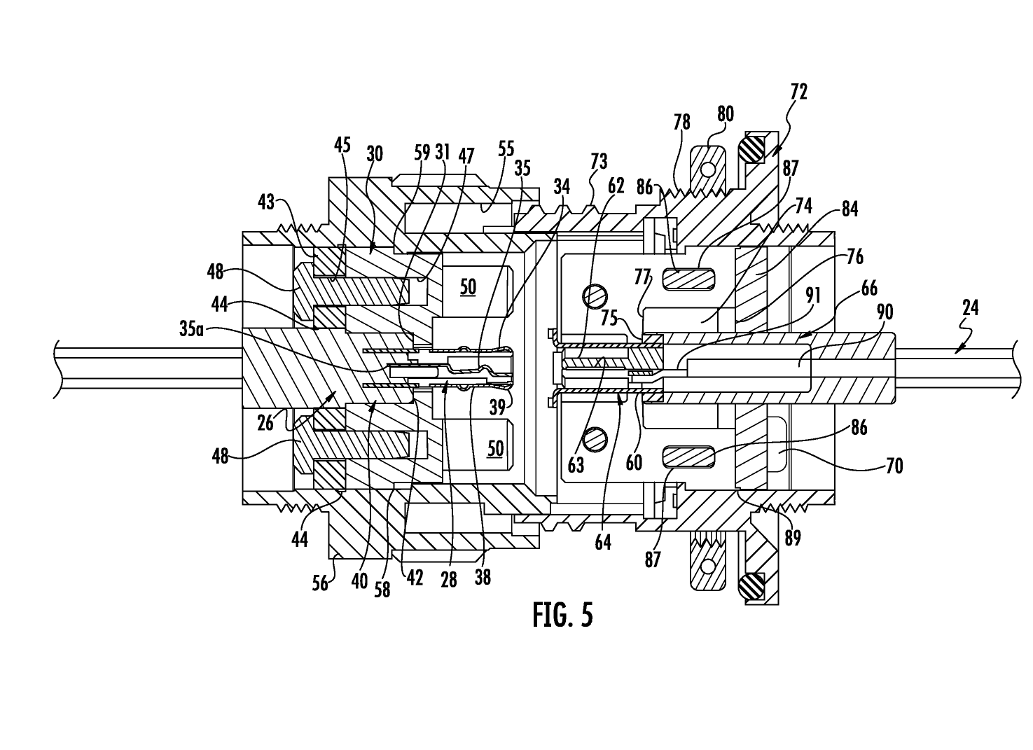

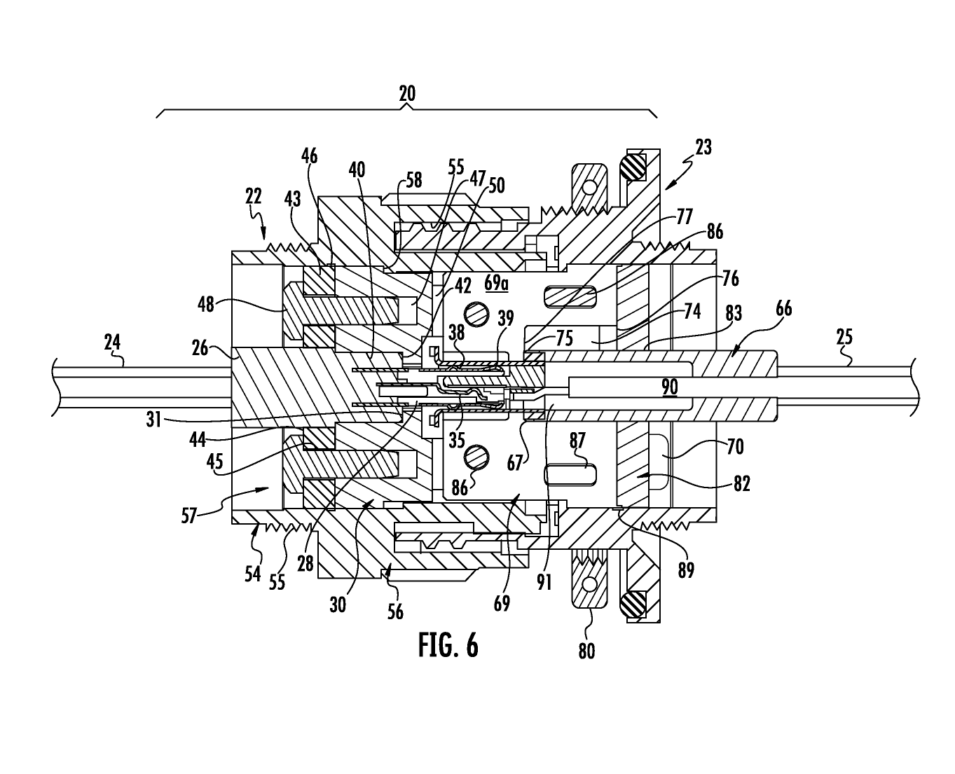

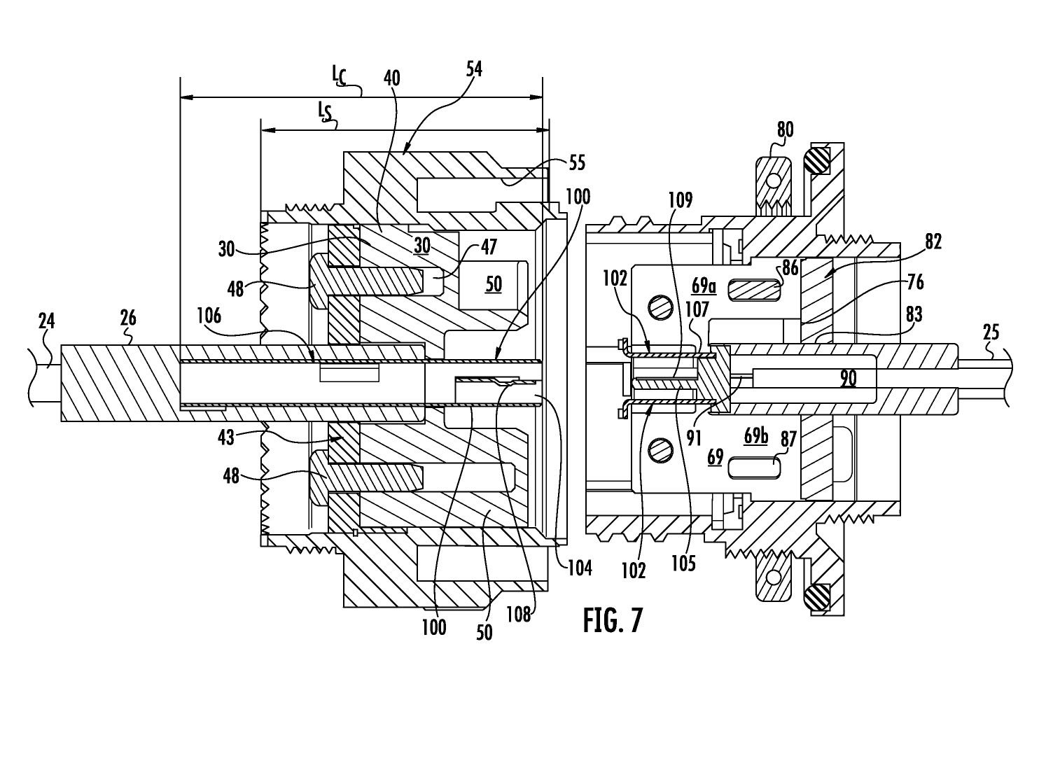

FIG. 7 is a sectional view of the connector assembly 20, wherein the connector halves 100, 102 are of the USB style. The left, or first connector half 100 is a female receptacle connector with a hollow interior 104 that receives the right, or second connector half mating blade 105 therein of the male connector 102. This mating, as with the eSata style connector halves described above and shown in FIGS. 1-6, occurs in a linear, axial movement so that the contacts 108, 109 of the connector halves 100, 102 mate in a linear and axial fashion, sliding upon each other and maintain contact via the normal pressure applied by the contacts of the female connector half 100, while the coupling of the outer connector shells 54, 72 together occurs in an arcuate, rotational movement. In this embodiment and as shown best in FIG. 8, the first grounding shield 106 has a length LC that is larger than the length LS of the first connector shell 54. In this regard, the first grounding shield 106 extends past the rear edge of the first connector shell and stops slightly short of the front edge of the first connector shell 54 (FIG. 7). When the two grounding shields 106, 107 are mated together, they have a combined length that exceeds the length of at least one of the two connector shells 54, 72 and in any event a length that is longer than any length of the exterior threads 55, 73 on the connector shells 54, 72. This length provides a ground reference for the connector contacts 108, 109 that is substantially uniformly spaced around the contacts. The second grounding shield 107 encloses the mating blade 105 and its contacts 109 and has a length less than its associated connector shell 72.

In this manner, high speed operation of these connectors may be achieved at minimal cost as only one ground is provided for each plurality of contacts for each respective male and female connector half, rather than providing individual grounds for each single contact as would be the case if conductive pins were used for the contacts. The connector inserts, by way of their insulative housings and baseplates are non-conductive and thus the connector shells may be either formed from or plated with a conductive material to provide the connector assembly 20 with an outer, exterior ground that matches that of the cables 24, 25.

While a preferred embodiment of the Present Disclosure is shown and described, it is envisioned that those skilled in the art may devise various modifications without departing from the spirit and scope of the foregoing Description and the appended Claims.

What is claimed is:

1. A connector assembly, comprising:
first and second interengaging connector shells;
first and second insulative connector housings respectively supported by the first and second connector shells; and
first and second connector halves respectively supported by the first and second connector housings, each connector half including respective first and second pluralities of conductive contacts arranged within their respective connector housings in at least one linear row, the first and second contacts extending transversely with respect to axes of the first and second connector shells, the first connector half including a female receptacle portion that extends axially within the first connector housing, the female receptacle portion supporting the first contacts thereon, the first connector housing further including a first conductive grounding shield that at least partially encloses the first contacts, the second connector half including a male mating portion that extends within the second connector housing, the male mating portion supporting the second contacts thereon, the second connector housing including a second conductive grounding shield that at least partially encloses the second contacts, the first and second contacts being disposed within their respective connector halves such that when the first and second connector housings are engaged together in a linear, axial movement, the first and second contacts are mated together and the first and second grounding shields engage each other, the first and second grounding shields having a length, when engaged, larger than a length of one of the first and second connector shells;
wherein:
the first and second connector housings include complementary, interengaging members that align the first and second connector halves together prior to and during mating; and
the first and second connector shells engage each other only by way of an arcuate rotational mating movement.

2. The connector assembly of claim 1, wherein each first and second connector housing interengaging members include corresponding lugs and recesses arranged in a pattern which permits only proper mating together of the first and second connector elements.

3. The connector assembly of claim 1, wherein each first and second connector elements include respective first and second baseplates, each first and second baseplates including an opening through into which the first and second connector halves respectively extend.

4. The connector assembly of claim 3, wherein the first and second connector halves are held within respective first and second connector body portions, and the first and second connector body portions respectively projecting through the first and second baseplate openings.

5. The connector assembly of claim 1, wherein the first and second connector body portions are supported within the first and second baseplates in a manner to prevent substantial lateral movement thereof during mating of the two connector housing halves.

6. The connector assembly of claim 3, wherein each first and second body connector portions include rear stop surfaces that respectively contact the first and second baseplates to prevent the first and second connector body portions to be pulled through the first and second baseplates.

7. The connector assembly of claim 3, wherein the first and second connector halves include forward stop surfaces that limit the extent to which the connector halves may extend though the connector housings.

8. The connector assembly of claim 3,wherein each first and second connector body portions are held between the first and second baseplates and the first and second connector housings in a compressive manner.

9. The connector assembly of claim 5, wherein the baseplates are attached to the connector housings to prevent relative movement therebetween, and to permit rotational movement of the baseplates and connector housings relative to the first and second connector shells.

10. The connector assembly of claim 1, wherein the first and second connector halves are USB style connectors.

11. The connector assembly of claim 1, wherein the first and second connectors are eSata style connectors.

12. The connector assembly of claim 1, wherein the first and second connector shells are conductive and provide an outer shield around the connector housings.

13. The connector assembly of claim 1, wherein the first and second connector shells engage each other in a quick connect/disconnect fashion.

14. The connector assembly of claim 1, wherein at least one of the first and second grounding shields has a length longer than its associated respective connector shell.

15. The connector assembly of claim 1, wherein when the first and second connector halves are mated together, the first and second grounding shield extend axially through the connector assembly for a length larger than a corresponding length of the threads on the connector element.

16. The connector assembly of Claim, wherein the first connector body portion is overmolded onto the first connector half, and a leading edge of the first connector body portion defines a forward stop surface of the first connector half.

17. A connector assembly, comprising:
first and second connector elements matable together,
the first connector element including a first connector housing supporting a female connector having a receptacle with a plurality of conductive first contacts supported thereby, the first contact including contact portions and opposing tail portions for termination to conductors of a first cable, the female connector being at least partially surrounded by a conductive first grounding shield,
the second connector element including a second connector housing supporting a male connector having a mating blade supporting a plurality of conductive second contacts supported thereby, the second contacts including contact portions and opposing tail portions for termination to conductors of a second cable, the second connector being at least partially surrounded by a conductive second grounding shield;
a first connector body extending around at least a portion of the female connector and the first grounding shield;
a second connector body extending around at least a portion of the male connector and the second grounding shield; and
first and second baseplates respectively disposed within the first and second connector elements, the first connector body being interposed between the first baseplate and the first connector housing and the second connector body being interposed between the second baseplate and the second connector housing, the first and second connector bodies being compressed between the baseplates and the connector housings.

18. The connector assembly of claim 17, wherein each first and second connector bodies include leading edges that respectively abut the first and second connector housings.

19. The connector assembly of claim 18, wherein the first and second connector bodies include respective stop surfaces that engage the first and second baseplates.

20. The connector assembly of claim 17, wherein one of the first and second grounding shields has a length longer than one of the first and second connector elements.
